(19) United States
(12) Patent Application Publication
(10) Pub. No.: US 2007/0070121 A1
(43) Pub. Date: Mar. 29, 2007

(54) Array head type printer and printing method using the same

(75) Inventor: Si-Joong Jang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/511,358

(22) Filed: Aug. 29, 2006

(30) Foreign Application Priority Data
Sep. 27, 2005 (KR) 10-2005-0089689

(51) Int. Cl. B41J 2/15

(52) U.S. Cl. 347/40

(57) ABSTRACT

An array head type printer and a printing method using an array head type printer are provided. The array head type printer includes an array head with a plurality of unit heads for spraying ink according to received printing data, and a head control unit for distinguishing between used unit heads and unused unit heads and converting the printing data to data to be received by the unit heads determined to be in use. Since unit heads are inactivated in the inkjet array head printer when they do not correspond to a printing area, it is possible to reduce the power consumption for driving the unit heads.

### PRIORITY

This application claims the benefit under 35 U.S.C. § 119(a) of Korean Patent Application No. 10-2005-0089689, filed Sep. 27, 2005, in the Korean Intellectual Property Office, the entire disclosure of which is hereby incorporated by reference.

### BACKGROUND OF THE INVENTION

1. Field of the Invention

The present invention relates to data printing. More particularly, the present invention relates to an array head type printer with an inkjet array head and a printing method using the array head type printer.

2. Description of the Related Art

Conventional head controllers for printers with an inkjet array head transmit printing data to the array head. The head controller divides the printing data according to the printing: area corresponding to each unit head of the array. The head controller then converts the data per per format. After this, the head controller transmits the converted data to the unit heads, and each unit head determines whether the received data is printing data or a printing command.

Because power is supplied to unit heads regardless of whether a unit head corresponds to a printing area or is not currently in use, power consumption of the printer is high.

### SUMMARY OF THE INVENTION

Accordingly, exemplary embodiments of the present invention provide an array head type printer having reduced power consumption for driving unit heads and method using the same.

According to an aspect of exemplary embodiments of the present invention, an array head type printer is provided comprising an array head with a plurality of unit heads for spraying ink according to printing data received, and a head control unit for distinguishing between used unit heads and unused unit heads and converting the printing data into data to be received by the distinguished unit heads.

According to another aspect of exemplary embodiments of the present invention, there is provided a printing method using an array head type printer. The printing method comprises distinguishing between used unit heads and unused unit heads and converting printing data into data to be received by the distinguished used unit heads, and receiving the converted printing data and spraying ink according to the printing data received.

### BRIEF DESCRIPTION OF THE DRAWINGS

The above and other aspects, exemplary features and advantages of the present invention will become more apparent from the following detailed description of certain exemplary embodiments thereof when taken in conjunction with the accompanying drawings in, which:

FIG. 1 is a block diagram of an array head type printer according to an exemplary embodiment of the present invention;

FIG. 2 is a block diagram of the head control unit in FIG. 1 according to an exemplary embodiment of the present invention;

FIG. 3 shows an example of printing data for used unit heads and unused unit heads, according to an exemplary embodiment of the present invention.

FIG. 4 shows an example of data converted by the data conversion unit in FIG. 2, according to an exemplary embodiment of the present invention;

FIG. 5 is a flow chart of a printing method using an array head type printer according to an exemplary embodiment of the present invention; and

FIG. 6 is a flow chart of the data conversion of FIG. 5 according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

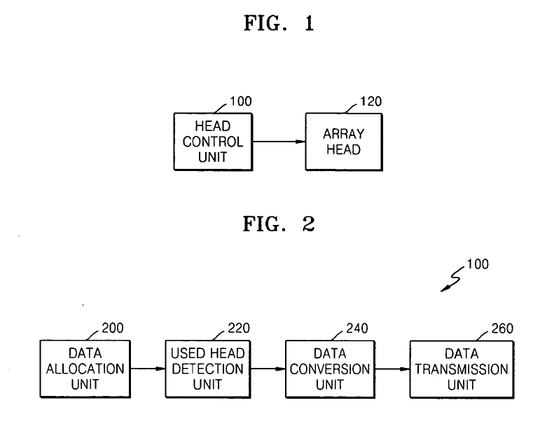

FIG. 1 is a block diagram of an array head type printer according to an exemplary embodiment of the present invention. Referring to FIG. 1, the array head type printer includes a head control unit 100 and an array head 120.

The head control unit 100 distinguishes between used unit heads and unused unit heads for printing data and converts the printing data into data to be used by the used unit heads and outputs the converted result to the array head 120. The unit heads are included in the array head.

FIG. 2 is a block diagram of the head control unit 100 in FIG. 1 according to an exemplary embodiment of the present invention. Referring to FIG. 2, the head control unit 100 includes a data allocation unit 200, a used head detection unit 220, a data conversion unit 240, and a data transmission unit 240.

The data allocation unit 200 allocates the printing data per unit head, and outputs the allocated result to the used head detection unit 220. The data per unit head comprises the data for printing operation to be performed in each unit head.

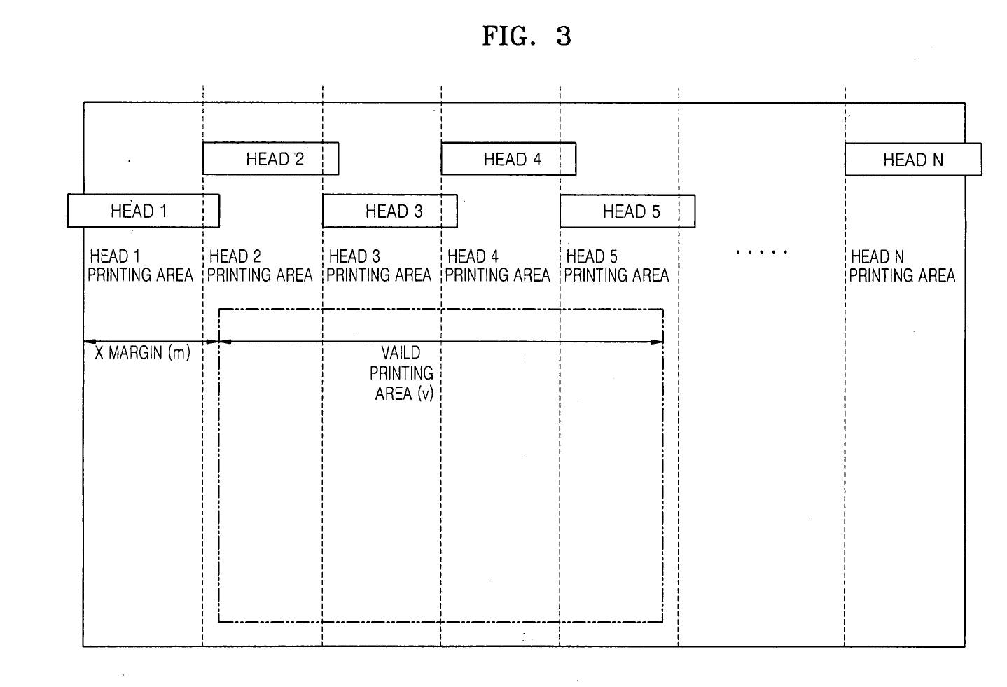

FIG. 3 shows an example of printing for used unit heads and unused unit heads. As shown in FIG. 3, unit heads 2 to 5 correspond to a valid printing area (v), and unit heads 1 and 6 to N correspond to an area where printing is not performed.

As shown in FIG. 3, the data allocation unit 200 allocates the data to unit heads 2 to 5 corresponding to the valid printing area.

The used head detection unit 220 detects the used unit heads and the unused unit heads according to the allocated data per unit head, and outputs the detected result to the data conversion unit 240. For example, in the case of the printing area shown in FIG. 3, the used head detection unit 220 detects that the unit heads used for printing are unit heads 2 to 5, and the unit heads not used for printing are unit heads 1 and 6 to N.

The data conversion unit 240 converts the data per unit head into a proper format according to the allocated data by the data allocation unit 200 and the detected result by the used head detection unit 220, and outputs the converted data to the data transmission unit 260.

The data conversion unit 240 adds a unit head inactivation signal as header information to the data for the unused unit heads.

The unit head inactivation signal stops generation of the clock signal for driving the unit head.

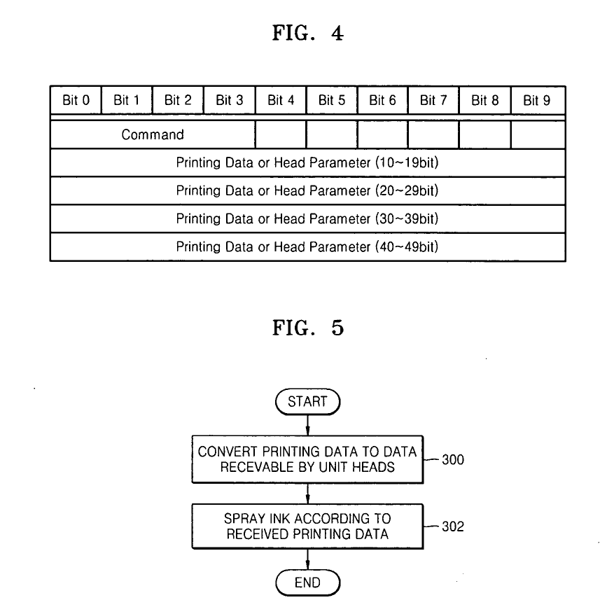

FIG. 4 shows an example of data converted by the data conversion unit 240 into data to be received by the unit heads. As shown in FIG. 4, the data conversion unit 240 adds a unit head inactivation signal as header information to the data for the unused unit heads at the position “Command.” The unit head inactivation signal can be called “sleep command.”

The data conversion unit 240 adds a unit head activation signal as header information to the data for the used unit heads. The unit head activation signal can be called “wake up command.”

The data conversion unit 240 converts the data for unused unit heads to a signal, such as “0” and “1.” For example, the data for unused unit heads 1 and 6 to N are converted to one of the signals “0” and “1,” respectively. Thus, it is possible to raise the efficiency of transmitting the signal and thereby reduce the power consumption.

The data transmission unit 260 transmits the converted printing data to the array head. In an exemplary implementation, the data transmission unit 260 transmits the converted data in a serial transmission.

The array head 120 sprays ink from the used unit heads according to the received printing data from the head control unit 100. That is, each unit head of the array head 120 receives the data allocated per unit head, and sprays the ink by analyzing the received data per unit head.

The array head 120 determines whether the unit head inactivation signal is included in the header information of the received data per unit head, and stops driving the unit head when the unit head inactivation signal is included. To stop driving the unit head, the array head 120 discontinues generating the clock signal for driving the unit head.

The array head 120 can reset the clock signal for driving the unit head when the array head receives the unit head inactivation signal. By resetting the clock signal, the array head stops driving the unit head receiving the unit head inactivation signal.

A printing method using an array head type printer according to the present invention will be described in detail with reference to the accompanying drawings.

FIG. 5 is a flow chart of a printing method using an array head type printer according to an exemplary embodiment of the present invention. The method of FIG. 5 will be described in conjunction with FIGS. 3 and 4.

Used unit heads are distinguished from unused unit heads and printing data is converted into data to be received by the unit heads, step 300.

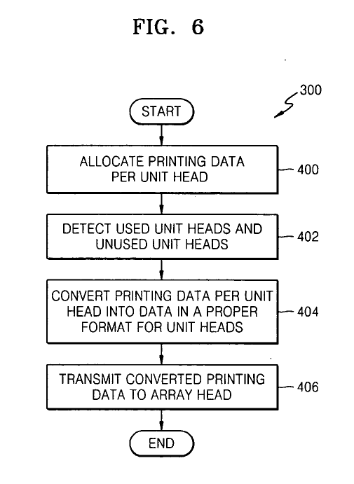

FIG. 6 is a flow chart of the data conversion of FIG. 5 according to an exemplary embodiment of the present invention.

First, printing data per unit head is allocated, step 400. As shown in FIG. 3, the unit heads 2 to 5 correspond to a valid printing area (v), and unit heads 1 and 6 to N correspond to an area where printing is not performed. After the printing data is allocated, step 400, the used unit heads and the unused unit heads are detected according to the allocated data per unit head, step 402. Unit heads 2 to 5 are used for printing, and the unit heads 1 and 6 to N are not used for printing.

After unit head detection, step 402, the data per unit head is converted into data having a proper format for the unit heads, step 404. A unit head inactivation signal is added as header information to the data for the unused unit heads.

As shown in FIG. 4, a unit head inactivation signal is added as header information to the data for the unused unit heads at the position “Command.” A unit head activation signal is added as header information to the data for the used unit heads.

The data per unit head for the unused unit heads is converted to a signal, such as “0” and “1.” For example, the data per unit heads 1 and 6 to N is converted to one of the signals “0” and “1,” respectively.

After print data conversion, step 404, the converted printing data is transmitted to the array head, step 406. In an exemplary implementation, the converted data is transmitted in a serial transmission.

After data conversion, step 300, the converted printing data is received and the used unit heads spray ink according to the received printing data, step 302.

Each unit head receives the data per unit head allocated thereto and sprays ink by analyzing the received data. It is determined whether the unit head inactivation signal is included in the header information of the received data per unit head, and driving the unit head receiving the unit head inactivation signal is stopped. To stop driving the unit head, the clock signal for driving the unit head is discontinued.

The clock signal for driving the unit head can be reset when the array head receives the unit head inactivation signal. By resetting the clock signal, driving of the unit head receiving the data, including the unit head inactivation signal, is stopped.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet).The computer readable medium can also be distributed over network coupled computer systems so that the computer readable code is stored and executed in a distributed fashion.

Functional programs, codes, and code segments for accomplishing exemplary embodiments of the present invention can be construed by programmers of ordinary skill in the art to which the present invention pertains.

While the array head type printer and the printing method using the array head type printer have been particularly shown and described with reference to exemplary embodiments thereof, it will be understood by those of ordinary skill in the art that various changes in form and detail may be made therein without departing from the spirit and scope of the present invention as defined by the appended claims and equivalents thereof.

The array head type printer and the printing method using the array head type printer according to exemplary embodiments of the present invention reduce the power consumption for driving the unit heads by inactivating the unit heads not corresponding to effective printing area.

The array head type printer and the printing method using the array head type printer according to exemplary embodiments of the present invention reduce power consumption due to data transmission and increase the data transmission speed by reducing the amount of data transmitted.

What is claimed is:

1. An array head type printer comprising:
an array head comprising a plurality of unit heads that spray ink according to printing data; and
a head control unit for distinguishing between used unit heads and unused unit heads and converting the printing data into data for the used unit heads and unused unit heads, respectively.

2. The array head type printer of claim 1, wherein the head control unit comprises:
a data allocation unit allocating for printing data per unit head;
a used head detection unit for detecting the used unit heads and the unused unit heads from the allocated printing data per unit head;
a data conversion unit for converting the allocated printing data per unit head into formatted data;
a data transmission unit for transmitting the converted printing data to the array head.

3. The array head type printer of claim 2, wherein the data conversion unit adds a unit head inactivation signal as header information to the data for the unused unit heads.

4. The array head type printer of claim 3, wherein the data conversion unit converts the data for the unused unit heads to a signal comprising at least one of “0” and “1.”

5. The array head type printer of claim 2, wherein the data transmission unit transmits the converted data in a serial transmission.

6. The array head type printer of claim 3, wherein the array head discontinues a unit head clock signal when the array head receives the unit head inactivation signal.

7. The array head type printer of claim 3, wherein the array head resets a unit head driving clock signal when the array head receives the unit head inactivation signal.

8. A printing method using an array head type printer, the method comprising:
distinguishing between used unit heads and unused unit heads;
converting printing data into data for the used unit heads and unused unit heads, respectively; and
spraying ink of the unit heads according to the converted printing data.

9. The method of claim 8, further comprising:
allocating printing data per unit head;
detecting the used and unused unit heads from the allocated printing data per unit head;
converting the printing data per unit head into data formatted for the detected unit heads; and
transmitting the converted printing data to an array head.

10. The method of claim 9, further comprising:
adding a unit head inactivation signal as header information to the converted printing data for the unused unit heads.

11. The method of claim 10, further comprising:
converting the printing data for the unused unit heads to a signal comprising at least one of “0” and “1.”

12. The method of claim 9, wherein transmitting the converted printing data comprises transmitting the converted data in a serial transmission.

13. The method of claim 10, further comprising:
discontinuing a unit head driving clock signal when the array head receives the unit head inactivation signal.

14. The method of claim 10, further comprising:
resetting a unit head driving clock signal when the array head receives the unit head inactivation signal.

15. A computer readable medium having stored thereon instructions for executing a printing method using an array head type printer, the instructions comprising:
a first set of instructions for distinguishing between used unit heads and unused unit heads;
a second set of instructions for converting printing data into data for the used unit heads and unused unit heads, respectively; and
a third set of instructions for spraying ink of the unit heads according to the converted printing data.

16. The instructions of claim 15, further comprising:
a fourth set of instructions for allocating printing data per unit head;
a fifth set of instructions for detecting the used and unused unit heads from the allocated printing data per unit head;
a sixth set of instructions for converting the printing data per unit head into data formatted for the detected unit heads; and
a seventh set of instructions for transmitting the converted printing data to an array head.

17. The instructions of claim 16, further comprising:
an eight set of instructions for adding a unit head inactivation signal as header information to the converted printing data for the unused unit heads.

18. The instructions of claim 17, further comprising:
a ninth set of instructions for converting the printing data for the unused unit heads to a signal comprising at least one of “0” and “1.”

19. The instructions of claim 16, wherein transmitting the converted printing data comprises transmitting the converted data in a serial transmission.

20. The instructions of claim 17, further comprising:
a tenth set of instructions for discontinuing a unit head driving clock signal when the array head receives the unit head inactivation signal.

21. The instructions of claim 17, further comprising:
an eleventh set of instructions for resetting a unit head driving clock signal when the array head receives the unit head inactivation signal.

22. The array head type printer of claim 2, wherein the data is formatted according to the allocation of the data allocation unit and the result detected by the used head detection unit.
